(19) United States
(12) Patent Application Publication
(10) Pub. No.: US 2023/0407898 A1
(43) Pub. Date: Dec. 21, 2023

(54) RATTAN-WEAVED FURNITURE INTERLOCKING MECHANISM

(71) Applicant: Rongwei CAI, Taizhou (CN)

(72) Inventor: Rongwei CAI, Taizhou (CN)

(21) Appl. No.: 17/850,415

(22) Filed: Jun. 27, 2022

(30) Foreign Application Priority Data
May 18, 2022 (CN) 2022212177337

(51) Int. Cl. F16B 12/14

(52) U.S. Cl. CPC F16B 12/14

(57) ABSTRACT

A rattan-weaved furniture interlocking mechanism includes a first bracket and a second bracket, the first bracket is provided with a first rod, the second bracket is provided with a second rod, and the first rod and the second rod are coupled each other; the first rod is provided with at least two locking devices, the second rod is provided with at least two fasteners, the locking devices and the fasteners are coupled with each other, and the locking devices are detachably connected with the corresponding fasteners, so that the first rod on the first bracket is fixedly connected with the second rod on the second bracket.

### TECHNICAL FIELD

The present disclosure relates to the technical field of furniture connectors, in particular to a rattan-weaved furniture interlocking mechanism.

### BACKGROUND

With the development of economy and the improvement of living standard, certain traditional furniture cannot meet the demand for quality by consumers. An increased variety of leisure furniture products are coming into lives of people. Rattan products, such as rattan-weaved sofas, take into account bot aethestatics and comfort, and fully meet the demand of improving the quality of life of people. For the production of rattan-weaved sofas, parts of the sofa need to be weaved independently and then assembled with the bracket part. Shortening assembly time and improving production efficiency have become the top priority for all manufacturers to strive for excellence. The existing bracket structure of rattan-weaved sofas is locked by screws, but it takes time and labor to tighten the screws, and more importantly, the screws will have some bad effects such as loosening during long-term use. Therefore, the prior art needs to be improved and developed.

### SUMMARY

Aiming at the defects and deficiencies of the prior art, the present disclosure provides a rattan-weaved furniture interlocking mechanism, which is reasonable structure in and convenient to assemble, and can effectively improve the production efficiency.

In order to achieve the above purpose, the present disclosure uses the following technical scheme.

The present disclosure relates to a rattan-weaved furniture interlocking mechanism, comprising a first bracket and a second bracket, wherein the first bracket is provided with a first rod, the second bracket is provided with a second rod, and the first rod and the second rod are paired with each other; the first rod is provided with at least two locking devices, the second rod is provided with at least two fasteners, the locking devices and the fasteners are paired with each other, and the locking devices are detachably connected with the corresponding fasteners, so that the first rod on the first bracket is fixedly connected with the second rod on the second bracket.

According to the above scheme, the locking device comprises a fixed seat, the fixed seat is provided with a wrench and a movable connecting rod, one end of the wrench is rotatably connected with the fixed seat; one end of the movable connecting rod is rotatably connected with the middle of the wrench, and the other end of the movable connecting rod is provided with a locking member paired with the fastener.

According to the above scheme, the fixed seat has an L-shaped bent structure, the fixed seat is attached to and is fixedly connected with the first rod, both sides of the fixed seat are provided with folding lugs; the two folding lugs are integrally formed with the fixed seat, one end of the wrench penetrates between the two folding lugs, and the wrench is rotatably connected with the two folding lugs, respectively.

According to the above scheme, the wrench is provided with two traction arms, the two traction arms are spaced apart from each other, the traction arms are integrally formed with the wrench, one end of the traction arms is rotatably connected with the corresponding folding lugs, respectively; one end of the movable connecting rod penetrates between the two traction arms, and the movable connecting rod is rotatably connected with the two traction arms, respectively.

According to the above scheme, one end of the movable connecting rod is provided with an anchor post, the anchor post penetrates between the two traction arms, and both ends of the anchor post are rotatably connected with the corresponding traction arms, respectively.

According to the above scheme, the fastener has a Z-shaped bent structure, one end of the fastener is attached to and is fixedly connected with the second rod, the locking member is provided with a keyhole, and the locking member is capable of being sleeved on the fastener through the keyhole and is detachably connected therewith.

According to the above scheme, the first bracket is provided with several positioning pins, the second bracket is provided with several pin holes, and the positioning pins pass through the corresponding pin holes when the first bracket is paired with the second bracket.

According to the above scheme, the first bracket is provided with several clamping pins, the second bracket is provided with several cartridges, and the clamping pins are hooked to the corresponding cartridges when the first bracket is paired with the second bracket.

The present disclosure has the following beneficial effects. The present disclosure has a reasonable structure. The first rod and the second rod can be provided on the pairing assembly surfaces of the first bracket and the second bracket, respectively, so that the first bracket and the second bracket are combined in a more flexible manner; a positioning pin is paired with a pin hole, a clamping pin and a cartridge for positioning, and the locking device is in fit connection with the fastener, so that the first bracket and the second bracket can be quickly connected, and the assembly efficiency can be effectively improved.

### BRIEF DESCRIPTION OF THE DRAWINGS

FIG. 1 is a schematic diagram of the overall assembly structure of the present disclosure.

FIG. 2 is an enlarged structural schematic diagram of part A in FIG. 1.

FIG. 3 is an enlarged structural schematic diagram of part B of Embodiment 1 in FIG. 1.

FIG. 4 is an enlarged structural schematic diagram of part B of Embodiment 2 in FIG. 1.

In the figures:

1. First bracket; 2. Second bracket; 3. Locking device; 4. Wrench; 11. First rod; 12. Positioning pin; 13. Clamping pin; 21. Second rod; 22. Fastener; 23. Pin hole; 24. Cartridge; 31. Fixed seat; 32. Folding lug; 41. Movable connecting rod; 42. Locking member; 43. Anchor post; 44. Keyhole; 45. Traction arm.

### DETAILED DESCRIPTION OF THE EMBODIMENTS

The technical scheme of the present disclosure will be described with reference to the drawings and embodiments hereinafter.

### Embodiment 1

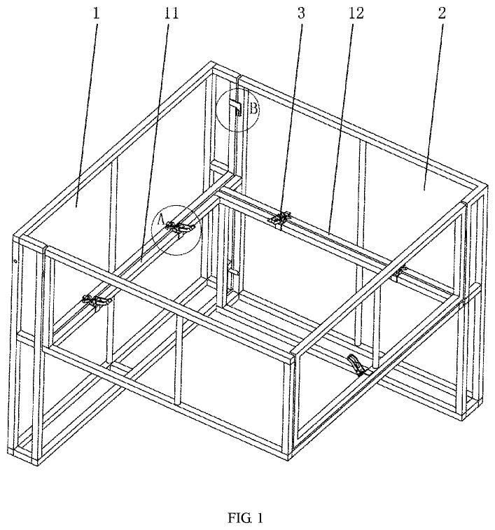

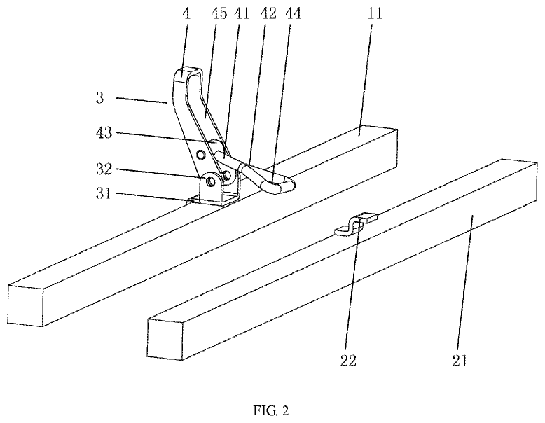

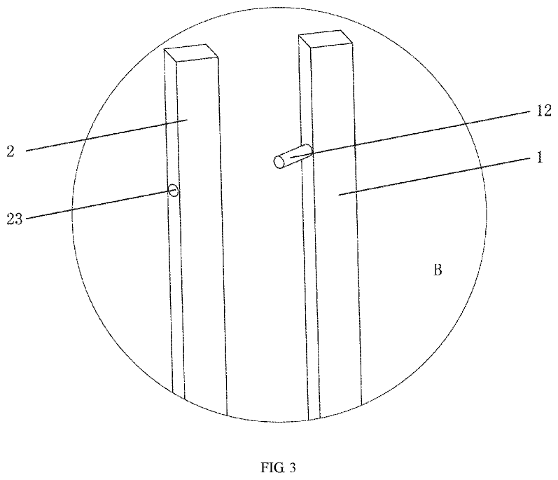

As shown in FIGS. 1-3, a rattan-weaved furniture interlocking mechanism according to the present disclosure comprises a first bracket 1 and a second bracket 2. The first bracket 1 is provided with a first rod 11, the second bracket 2 is provided with a second rod 21, and the first rod 11 and the second rod 21 are paired with each other; the first rod 11 is provided with at least two locking devices 3, the second rod 21 is provided with at least two fasteners 22, the locking devices 3 and the fasteners 22 are paired with each other, and the locking devices 3 are detachably connected with the corresponding fasteners 22, so that the first rod 11 on the first bracket 1 is fixedly connected with the second rod 21 on the second bracket 2. The locking device 3 is paired with the fastener 22 to quickly connect the first rod 11 and the second rod 21 fixedly. Preferably, the first bracket 1 and the second bracket 2 are provided with a plurality of first rods 11 and second rods 21. The plurality of first rods 11 and second rods 21 are provided on the pairing surfaces of the first bracket 1 and the second bracket 2, respectively, and the first rods 11 and the second rods 21 are provided with a plurality of locking devices 3 and corresponding fasteners 22, so that the first bracket 1 and the second bracket 2 are connected with each other in multiple points as a whole. In particular, the first bracket 1 and the second bracket 2 can be arranged in manner of front and back, up and down, left and right, and then a plurality of first brackets and second brackets 2 can be superimposed to form a bracket structure suitable for rattan-weaved furniture with different structures and shapes. The locking device 3 can effectively improve the assembly efficiency of rattan-weaved furniture.

The locking device 3 comprises a fixed seat 31, the fixed seat 31 is provided with a wrench 4 and a movable connecting rod 41, one end of the wrench 4 is rotatably connected with the fixed seat 31; one end of the movable connecting rod 41 is rotatably connected with the middle of the wrench 4, and the other end of the movable connecting rod 41 is provided with a locking member 42 paired with the fastener 22. One end of the wrench 4 is rotatably connected with the fixed seat 31 to drive the movable connecting rod 41 to rotate around the fixed seat 31. When the wrench 4 is on the side of the fastener 22, the other end of the movable connecting rod 41 can be in pairing connection with the fastener 22 through a locking member 42, and then the wrench 4 is rotated away from the fastener 22. The locking member 42 cooperates with the fastener 22 to lock and fix the first rod 11 and the second rod 21.

The fixed seat 31 has an L-shaped bent structure, the fixed seat 31 is attached to and is fixedly connected with the first rod 11, both sides of the fixed seat 31 are provided with folding lugs 32; the two folding lugs 32 are integrally formed with the fixed seat 31, one end of the wrench 4 penetrates between the two folding lugs 32, and the wrench 4 is rotatably connected with the two folding lugs 32, respectively. The fixed seat 31 can be welded to the first rod 11 or can be fixed on the first rod by bolts. The space between the two folding lugs 32 is used for the movable connecting rod 41 to rotate on the fixed seat 31. The folding lugs 32 and the fixed seat 31 are integrally formed, and the fixed seat 31 is a stamping part, which has the advantages of convenient processing, low production cost and strong versatility.

The wrench 4 is provided with two traction arms 45. The two traction arms 45 are spaced apart from each other, and the traction arms 45 are integrally formed with the wrench 4. One end of the traction arms 45 is rotatably connected with the corresponding folding lugs 32, respectively; one end of the movable connecting rod 41 penetrates between the two traction arms 45, and the movable connecting rod 41 is rotatably connected with the two traction arms 45, respectively. The traction arm 45 is used for rotatably connecting the wrench 4 with the fixed seat 31. The traction arm 45 is connected with the folding lug 32 by rivets and is rotatable therebetween. The movable connecting rod 41 relatively penetrates between the two traction arms 45, and then the movable connecting rod 41 is rotatably connected with the traction arm 45 so that the movable connecting rod is rotatable relative to the wrench 4 and the fixed seat 31.

One end of the movable connecting rod 41 is provided with an anchor post 43, the anchor post 43 penetrates between the two traction arms 45, and both ends of the anchor post 43 are rotatably connected with the corresponding traction arms 45, respectively. The two end faces of the anchor post 43 can be in clearance-fit with the traction arms 45. The anchor post 43 serves as a filling support structure between the traction arms 45 to improve the structural strength of the wrench 4 and the traction arms 45. Both ends of the anchor post 43 are rotatably connected with the traction arms 45 through rivets.

The fastener 22 has a Z-shaped bent structure. One end of the fastener 22 is attached to and is fixedly connected with the second rod 21. The locking member 42 is provided with a keyhole 44. The locking member 42 is capable of being sleeved on the fastener 22 through the keyhole 44 and is detachably connected therewith.

The first bracket 1 is provided with several positioning pins 12. The second bracket 2 is provided with several pin holes 23. The positioning pins 12 pass through the corresponding pin holes 23 when the first bracket 1 is paired with the second bracket 2. When the first bracket 1 and the second bracket 2 are paired for assembly, the positioning pin 12 is paired with the pin hole 23 to ensure the position accuracy between the locking device 3 and the fastener 22 and improve the assembly efficiency.

### Embodiment 2

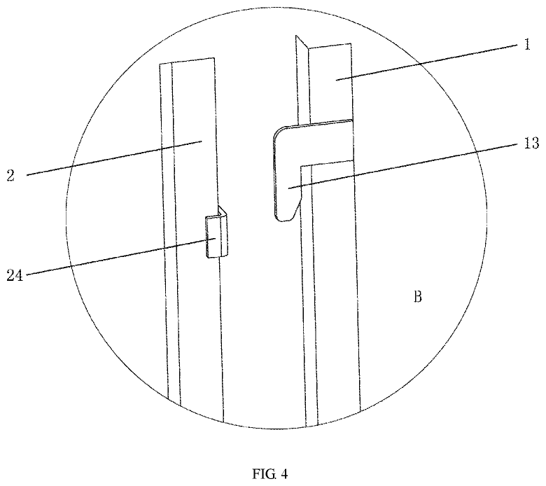

As shown in FIG. 4, the difference between this embodiment and Embodiment 1 is only that the first bracket 1 is provided with several clamping pins 13, the second bracket 2 is provided with several cartridges 24, and the clamping pins 13 are hooked to the corresponding cartridges 24 when the first bracket 1 is paired with the second bracket 2. The clamping pin 13 is paired with the cartridge 24 to ensure the position accuracy between the locking device 3 and the fastener 22 and improve the assembly efficiency.

The above are only the preferred embodiments of the present disclosure, so that all equivalent changes or modifications made according to the structure, characteristics and principles described in the patent application scope of the present disclosure are included in the patent application scope of the present disclosure.

1. A rattan-weaved furniture interlocking mechanism, comprising a first bracket (1) and a second bracket (2), wherein the first bracket (1) is provided with a first rod (11), wherein the second bracket (2) is provided with a second rod (21), and the first rod (11) and the second rod (21) are coupled with each other; wherein the first rod (11) is provided with at least two locking devices (3), wherein the second rod (21) is provided with at least two fasteners (22), wherein the locking devices (3) and the fasteners (22) are coupled with each other, and wherein the locking devices (3) are detachably connected with the corresponding fasteners (22), so that the first rod (11) on the first bracket (1) is fixedly connected with the second rod (21) on the second bracket (2).

2. The rattan-weaved furniture interlocking mechanism according to claim 1, wherein the locking device (3) further comprising a fixed seat (31), wherein the fixed seat (31) is provided with a wrench (4) and a movable connecting rod (41), wherein one end of the wrench (4) is rotatably connected with the fixed seat (31); wherein one end of the movable connecting rod (41) is rotatably connected with middle of the wrench (4), and another end of the movable connecting rod (41) is provided with a locking member (42) coupled with the fastener (22).

3. The rattan-weaved furniture interlocking mechanism according to claim 2, wherein the fixed seat (31) is an L-shaped bent structure, wherein the fixed seat (31) is attached to and fixedly connected with the first rod (11), wherein two sides of the fixed seat (31) are each provided with a folding lug (32); wherein the two folding lugs (32) are integrally formed in the fixed seat (31), wherein one end of the wrench (4) is coupled with the two folding lugs (32), so that the wrench (4) is rotatably connected with the two folding lugs (32).

4. The rattan-weaved furniture interlocking mechanism according to claim 3, wherein the wrench (4) is provided with two traction arms (45), wherein the two traction arms (45) are spaced apart from each other, wherein the traction arms (45) are integrally formed in the wrench (4), wherein one end of each traction arm (45) is rotatably connected with the corresponding folding lugs (32); wherein one end of the movable connecting rod (41) is coupled with the two traction arms (45), so that the movable connecting rod (41) is rotatably connected with the two traction arms (45).

5. The rattan-weaved furniture interlocking mechanism according to claim 4, wherein one end of the movable connecting rod (41) is provided with an anchor post (43), wherein the anchor post (43) is coupled to the two traction arms (45), and wherein both ends of the anchor post (43) are rotatably connected to a traction arm (45).

6. The rattan-weaved furniture interlocking mechanism according to claim 2, wherein the fastener (22) is a Z-shaped bent structure, wherein one end of the fastener (22) is coupled with the second rod (21), wherein the locking member (42) is provided with a keyhole (44), and wherein the locking member (42) is capable of being detachably connected to the fastener (22) through the keyhole (44).

7. The rattan-weaved furniture interlocking mechanism according to claim 1, wherein the first bracket (1) is provided with a plurality of positioning pins (12), wherein the second bracket (2) is provided with a plurality of pin holes (23), and wherein each positioning pine (12) passes through a corresponding pin hole (23) when the first bracket (1) is paired with the second bracket (2).

8. The rattan-weaved furniture interlocking mechanism according claim 2, wherein the first bracket (1) is provided with a plurality of positioning pins (12), wherein the second bracket (2) is provided with a plurality of pin holes (23), and wherein each positioning pine (12) passes through a corresponding pin hole (23) when the first bracket (1) is paired with the second bracket (2).

9. The rattan-weaved furniture interlocking mechanism according to claim 3, wherein the first bracket (1) is provided with a plurality of positioning pins (12), wherein the second bracket (2) is provided with a plurality of pin holes (23), and wherein each positioning pine (12) passes through a corresponding pin hole (23) when the first bracket (1) is paired with the second bracket (2).

10. The rattan-weaved furniture interlocking mechanism according claim 4, wherein the first bracket (1) is provided with a plurality of positioning pins (12), wherein the second bracket (2) is provided with a plurality of pin holes (23), and wherein each positioning pine (12) passes through a corresponding pin hole (23) when the first bracket (1) is paired with the second bracket (2).

11. The rattan-weaved furniture interlocking mechanism according to claim 5, wherein the first bracket (1) is provided with a plurality of positioning pins (12), wherein the second bracket (2) is provided with a plurality of pin holes (23), and wherein each positioning pine (12) passes through a corresponding pin hole (23) when the first bracket (1) is paired with the second bracket (2).

12. The rattan-weaved furniture interlocking mechanism according claim 6, wherein the first bracket (1) is provided with a plurality of positioning pins (12), wherein the second bracket (2) is provided with a plurality of pin holes (23), and wherein each positioning pine (12) passes through a corresponding pin hole (23) when the first bracket (1) is paired with the second bracket (2).

13. The rattan-weaved furniture interlocking mechanism according to claim 1, wherein the first bracket (1) is provided with a plurality of clamping pins (13), wherein the second bracket (2) is provided with a plurality of cartridges (24), and wherein the clamping pins (13) are coupled to the corresponding cartridges (24) when the first bracket (1) is paired with the second bracket (2).

14. The rattan-weaved furniture interlocking mechanism according to claim 2, wherein the first bracket (1) is provided with a plurality of clamping pins (13), wherein the second bracket (2) is provided with a plurality of cartridges (24), and wherein the clamping pins (13) are coupled to the corresponding cartridges (24) when the first bracket (1) is paired with the second bracket (2).

15. The rattan-weaved furniture interlocking mechanism according to claim 3, wherein the first bracket (1) is provided with a plurality of clamping pins (13), wherein the second bracket (2) is provided with a plurality of cartridges (24), and wherein the clamping pins (13) are coupled to the corresponding cartridges (24) when the first bracket (1) is paired with the second bracket (2).

16. The rattan-weaved furniture interlocking mechanism according to claim 4, wherein the first bracket (1) is provided with a plurality of clamping pins (13), wherein the second bracket (2) is provided with a plurality of cartridges (24), and wherein the clamping pins (13) are coupled to the corresponding cartridges (24) when the first bracket (1) is paired with the second bracket (2).

17. The rattan-weaved furniture interlocking mechanism according to claim 5, wherein the first bracket (1) is provided with a plurality of clamping pins (13), wherein the second bracket (2) is provided with a plurality of cartridges (24), and wherein the clamping pins (13) are coupled to the corresponding cartridges (24) when the first bracket (1) is paired with the second bracket (2).

18. The rattan-weaved furniture interlocking mechanism according to claim 6, wherein the first bracket (1) is provided with a plurality of clamping pins (13), wherein the second bracket (2) is provided with a plurality of cartridges (24), and wherein the clamping pins (13) are coupled to the corresponding cartridges (24) when the first bracket (1) is paired with the second bracket (2).
